(19) United States
(12) Patent Application Publication
(10) Pub. No.: US 2014/0089213 A1
(43) Pub. Date: Mar. 27, 2014

(54) SYSTEMS AND METHODS FOR PROVIDING A MORTGAGE REALTOR PORTAL

(71) Applicants: John Plantada, San Antonio, TX (US); Craig A. Kincaid, Floresville, TX (US); Elizabeth Lynne Jackson, Helotes, TX (US); John Carr, San Antonio, TX (US)

(72) Inventors: John Plantada, San Antonio, TX (US); Craig A. Kincaid, Floresville, TX (US); Elizabeth Lynne Jackson, Helotes, TX (US); John Carr, San Antonio, TX (US)

(73) Assignee: UNITED SERVICES AUTOMOBILE ASSOCIATION (USAA), San Antonio, TX (US)

(21) Appl. No.: 13/974,253

(22) Filed: Aug. 23, 2013

Related U.S. Application Data
(60) Provisional application No. 61/705,043, filed on Sep. 24, 2012.

(51) Int. Cl. G06Q 50/16; G06Q 40/02

(52) U.S. Cl. CPC G06Q 50/16; G06Q 40/025
USPC 705/313

(57) ABSTRACT

Systems and methods of providing a mortgage portal to facilitate initiating a mortgage for closing on property. The system includes a server and several computing devices communicatively connected via a network. The server manages the information, documents, and tasks required to complete the mortgage, including generating alert conditions for notifications, presenting pending files to realtors and lenders, sending notifications for various deadlines, and sending notifications when information and/or documents are received.

### CROSS-REFERENCE TO RELATED APPLICATIONS

This application claims priority to U.S. Provisional Application Ser. No. 61/705,043, filed Sep. 24, 2012, the disclosure of which is incorporated herein by reference in its entirety.

### BACKGROUND OF THE INVENTION

A realtor is often caught in the middle of the relationship between mortgagor and prospective lendee. Mortgagors require prospective lendees to provide documents and information. Prospective lendees sometime fail to provide this information or provide it in an incomplete fashion. Until prospective lendee provides the documents and information, the transaction cannot close. Meanwhile, the realtor is attempting to drive the corresponding real estate transaction to a close.

The realtor has to coordinate communications between the lendee and the seller schedule inspections and set closing dates. The realtor wants to complete the sale as soon as possible. This goal is hampered, however, if the mortgagor and the lendee have not completed to the paperwork necessary to complete the transaction. Therefore, to make a real estate transaction run smoothly, the realtor must continually monitor the relationship between their client, the mortgagor, and their lending institution, the lendee to insure that all paperwork is being submitted and approved in a timely fashion. This is difficult, however, because the realtor can only determine this information through communication with their client and/or the mortgagor. This communication is time consuming because the parties are not always available. These inefficiencies introduce delay into real estate transactions and frustrate the intentions of the brokers. Accordingly, what is needed are systems and methods by which realtor can monitor the communications and paperwork flow between mortgagors and lendee.

### SUMMARY OF THE INVENTION

The illustrated embodiments and description herein relate to systems and methods of providing a mortgage portal to facilitate initiating a mortgage. In one embodiment, the system includes a server and several computing devices communicatively connected via a network. A lender may receive a request for a mortgage quote from a prospective borrower. The lender requests that the borrower provide the necessary information and documents. The information and documents are saved to the system, which may also generate a record of outstanding information and documents that the lender needs to receive.

A retrieval engine requests information about pending mortgage applications, wherein the requests may performed periodically for all applications or only upon request by someone such as a lender. A presentation engine generates an interface for various parties to access the information, the parties including the lenders, the borrowers, and the realtors. An alert engine may send notification to a party, such as a realtor, when information has been submitted by a lendee/borrower. The alert engine may also notify participants when certain milestones occur, such as completion of paperwork by the lendee or the expiration or pending expiration of deadlines. And the alert engine may alert a party (e.g., realtor) that another party (e.g., lendee), still needs to submit certain information.

### BRIEF DESCRIPTION OF THE DRAWINGS

So that those having ordinary skill in the art, to which the present illustrated embodiments pertain, will more readily understand how to employ the embodiments, the certain illustrated embodiments thereof will be described in detail herein-below with reference to the drawings, wherein:

FIG. 1 depicts one embodiment of a system on which a realtor portal operates;

FIG. 2 depicts one embodiment of the portal device 106 depicted in FIG. 1;

FIG. 3 is a flowchart depicting illustrative operation of the System of FIG. 1; and

FIGS. 4-9 depict an exemplary embodiment of a Realtor Portal in accordance with one aspect of the invention.

A component or a feature that is common to more than one drawing is indicated with the same reference number in each of the drawings.

### DETAILED DESCRIPTION OF CERTAIN EMBODIMENTS

The present disclosure is directed to a mortgage realtor portal and methods for operating the same, in the below illustrated embodiments. It is to be appreciated the subject invention is described below more fully with reference to the accompanying drawings, in which illustrated embodiments are shown. The illustrated embodiments described below are merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. All publications mentioned herein are incorporated herein by reference to disclose and describe the methods and/or materials in connection with which the publications are cited.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated that certain embodiments of this invention as discussed below are a software algorithm, program or code residing on computer useable medium having control logic for enabling execution on a machine having a computer processor. The machine typically includes memory storage configured to provide output from execution of the computer algorithm or program. As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

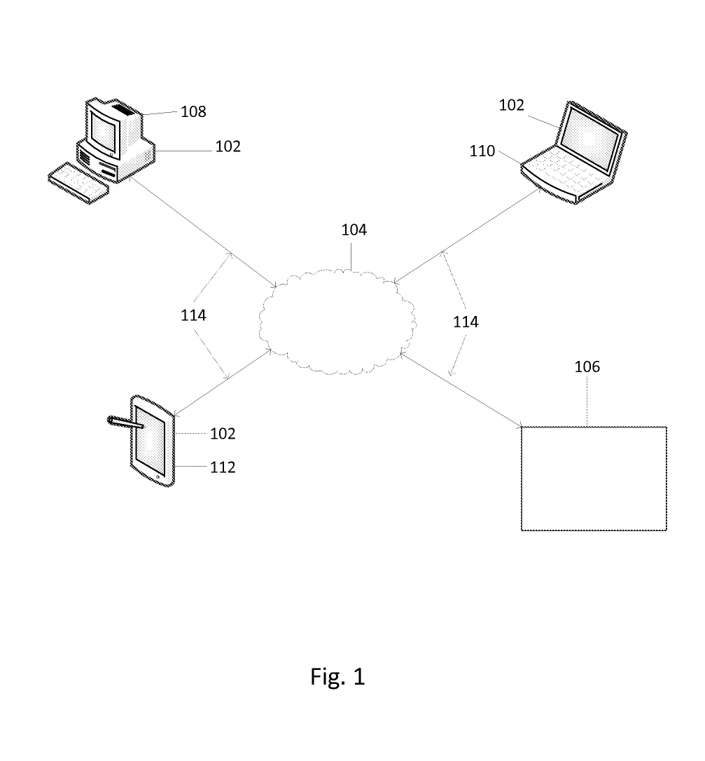

Referring to FIG. 1, illustrated therein is a hardware diagram depicting a system 100 in which the processes described herein can be executed. In one example, system 100 includes one or more participant devices 102, a network 104, and at least one portal device 106.

Exemplary embodiments of participant device 102 include but are not limited to mobile devices, such as a multifunction “smart phone”, a personal computer, a notebook computer, a tablet computer, and/or a server. It should be understood that devices 102 each generally include at least one processor, at least one data interface, and at least one memory device coupled via buses. Devices 102 may be capable of being coupled together, coupled to peripheral devices, and input/output devices. Devices 102, are represented in the drawings as standalone devices, but are not limited to such. Each can be coupled to other devices in a distributed processing environment. Devices 102 can communicate with each other and with exchange device 106 through network 104.

Participant device 102 in one example is a lendee device 108 that is operated by a prospective lendee. In another example, participant device 102 is a lender device 110 operated by a lender. In another example, participant device 102 is a realtor device 112 operated by a realtor. Lender device 108, lendee device 110, and realtor device 112 can communicate with each other over network 104, thereby allowing a lender, a lendee, and a realtor to communicate over network 104. A lender, lendee, and realtor could also communicate through other means, such as plain old telephone (POT) service or in person.

In one example, lender device 108 and lendee device 110 exchange information with each other over network 104. In one example, the lender requests information and documents from the lendee in order to process and close a mortgage loan transaction, and the prospective lendee provides information and documents to the lender. In one embodiment, the lender keeps a record in its memory of information and documents that the lender has received from the prospective lendee. In another embodiment, the lender device 110 keeps a record in memory of outstanding information and documents that the lender needs to receive from the lendee to process and close a mortgage loan transaction.

In one example, realtor device 112 retrieves information from portal device 106 regarding the status of a prospective mortgage loan transaction between a lender and a prospective lendee. In the illustrated embodiment of FIG. 1, realtor device 112 comprises a tablet, lendor device 108 comprises a desktop, and lendee device 110 comprises a laptop, though it will be understood by those skilled in the art that, as discussed above, devices 102 may be any computing device as known in the art.

Portal device 106 is one or more hardware and/or software components residing on a server or computer. In another example, portal device 106 is one or more hardware and/or software component residing on multiple servers or computers. In another example, portal device 106 is one or more hardware and/or software components residing on one or more participant devices 102. It should also be noted that portal device 106 may be capable of being coupled to other portal devices, coupled to peripheral devices, couple to input/output devices, and/or coupled to other systems. Portal device 106 is represented in the drawings as a standalone device, but it is not limited to such. Portal device 106 can be coupled to other devices in a distributed processing environment.

Referring further to FIG. 1, it is to be appreciated that network 104 depicted in FIG. 1 may include a local area network (LAN) and/or a wide area network (WAN), but may also include other networks such as a personal area network (PAN). Such networking environments are commonplace in offices, enterprise-wide computer networks, intranets, and the Internet. For instance, when used in a LAN networking environment, system 100 is connected to the LAN through a network interface or adapter (not shown). When used in a WAN networking environment, the computing system environment typically includes a modem or other means for establishing communications over the WAN, such as the Internet. The modem, which may be internal or external, may be connected to a system bus via a user input interface, or via another appropriate mechanism. In a networked environment, program modules depicted relative to the system 100, or portions thereof, may be stored in a remote memory storage device such as storage medium. Participant devices 102 and portal device 106 communicate over network 104 through one or more communications links 114 formed between data interfaces of participant devices 102 and exchange device 106, respectively. Communication links 114 may comprise either wired or wireless links. It is to be appreciated that the illustrated network connections of FIG. 1 are exemplary and other means of establishing a communications link between multiple devices may be used.

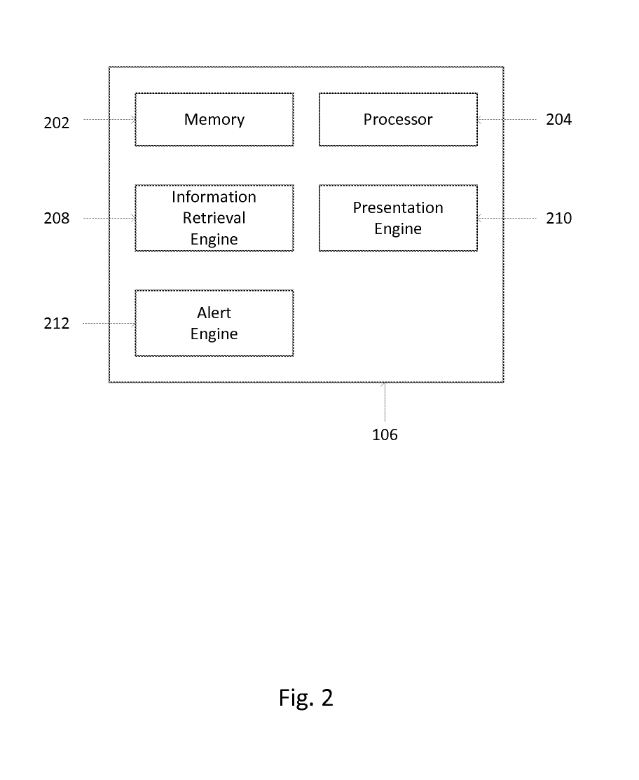

Referring to FIG. 2, portal device 106 includes a memory device 202, a processor 204, a data interface 206, an information retrieval engine 208, a presentation engine 210, and an alert engine 212.

Memory device 202 in one example comprises a computer-readable signal-bearing medium. One example of a computer-readable signal-bearing medium comprises a recordable data storage medium, such as a magnetic, optical, biological, and/or atomic data storage medium. In another example, a computer-readable signal-bearing medium comprises a modulated carrier signal transmitted over a network coupled with system 100, for instance, a telephone network, a local area network (“LAN”), the Internet, and/or a wireless network. In one example, memory device 202 includes a series of computer instructions written in or implemented with any of a number of programming languages, as will be appreciated by those skilled in the art. In yet another example, the computer instructions may be saved in a non-transitory computer-readable memory device, and executed by processor 204.

Memory device 202 in one example includes database 203. Database 203 in one example includes mortgage records. Such mortgage records include information about mortgage transactions between prospective lenders and lendees. Such information in one embodiment includes a listing of documents and information that are necessary for a mortgage file to be complete between a lender and a prospective lendee. Such documents and information in one example are information that the prospective lendee must provide the lender in order to receive a mortgage. In one embodiment, the database 203 includes an indication as to whether the prospective lendee has provided necessary information to the lender. In one embodiment, the database 203 includes an indication if documents or information submitted by the prospective lendee to the lender are sufficient relative to the lender's policies. In one embodiment, the database 203 includes an indication if the loan process is complete between the lender and prospective lendee. It should be noted that the proceeding information is provided for illustrative purposes only. Database 203 should not be limited to residing on portal device 106. Database 203 may include additional information and may reside on a participant device 102 or be spread across devices as part of a distributed computing environment.

Processor 204 is an electronic device configured of logic circuitry that responds to and executes instructions. The processor 204 could comprise more than one distinct processing devices, for example to handle different functions within portal device 106. Processor 204 outputs results of an execution of the methods described herein. Alternatively, processor 204 could direct the output to a remote device (not shown) via network 104.

Date interface 206 may include the mechanical, electrical, and signaling circuitry for communicating data over network 104. Interface 206 may be configured to transmit and/or receive data using a variety of different communication protocols and various network connections, e.g., wireless and wired/physical connections. However, it should be noted that the view used herein is merely for illustration. Interface 206 can further include an input device, such as a keyboard, a touch screen or a speech recognition subsystem, which enables a user to communicate information and command selections to processor 204. Interface 206 can also includes an output device such as a display screen, a speaker, a printer, etc. Interface 206 can further include an input device such as a touch screen, a mouse, track-ball, or joy stick, which allows the user to manipulate the display for communicating additional information and command selections to processor 204. Through utilization of interface 206, portal device 106 may be to peripheral devices, and/or input/output devices.

The term “engine” with reference to information retrieval engine 208, presentation engine 210, and alert engine 212 denotes a functional operation that may be embodied either as a stand-alone component or as an integrated configuration of a plurality of subordinate components. Thus, information retrieval engine 208, presentation engine 210, and alert engine 212 may be implemented as a single module or as a plurality of modules that operate in cooperation with one another. Moreover, information retrieval engine 208, presentation engine 210, and alert engine 212 could be implemented as software instructions in memory 202 or separately in any of hardware (e.g., electronic circuitry), firmware, software, or a combination thereof. In one embodiment, information retrieval engine 208, presentation engine 210, and an alert engine 212 contain instructions for controlling processor 204 to execute the methods described herein. Examples of these methods are explained in further detail in the subsequent of exemplary embodiments section-below.

Referring to FIG. 1, information retrieval engine 208 in one embodiment retrieves information from participate devices 102 regarding the status of mortgage loan status. For instance, information retrieval engine 208 communicates with lender device 110 to determine what documents and information have been submitted by prospective lendees and approved by lenders as part of loan transaction. Such documents and information include personal data (name, address, social security numbers, date of birth, etc.), assets, bank accounts, creditors, current housing information, and a sales contract for the prospective purchase. In one example, information retrieval engine 208 periodically requests this information for all pending mortgages between participant devices 102 and stores the information in database 203. In another example, information retrieval engine 208 requests this information only on an as-needed basis. For example, when a realtor device 112 requests information about the status of a pending mortgage, information retrieval engine 208 may request this information from lender device 110 and provide it to the realtor device 112. As part of such a transaction, portal device 106 may or may not store the updated status in database 203.

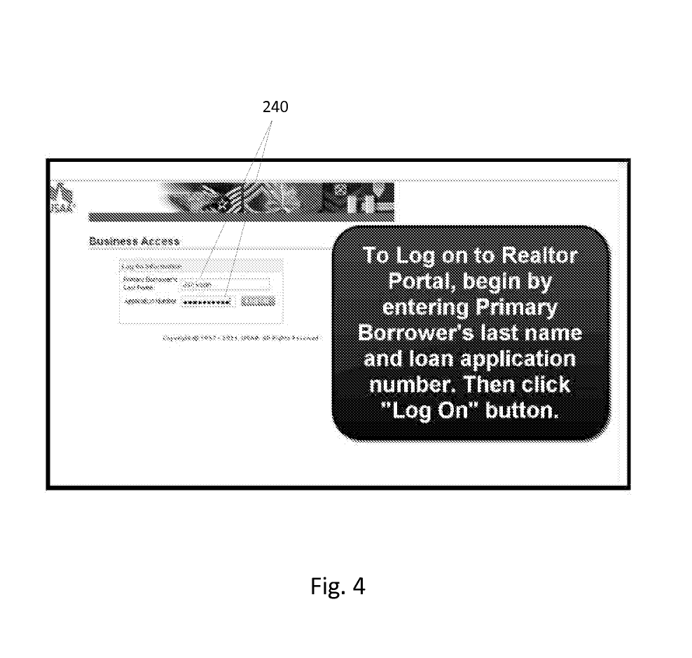

Referring to FIG. 2, presentation engine 210 is utilized to provide the status of a mortgage transaction to participant devices 102. In one example, presentation engine 210 provides textual data representing the status the mortgage transaction. In another example, presentation engine 210 provides multimedia data representing the status of a mortgage transaction. Such multimedia data could include text, audio, or visual data, or various combinations thereof. Such data may be provided through means such as email, text, SMS, social media, voicemail, etc. FIG. 4-9 depict exemplary embodiments of status information that presentation engine 210 provides to participant devices 102.

Referring to FIG. 2, alert engine 212 is utilized to provide alerts to participant devices regarding the status of mortgage loan transactions. For instance, when a prospective lendee submits a document or information to a lender, alert engine 212 may send an alert to realtor device 112 that information or a document has been received by a lender. In another example, if a lender approves of a document or piece of information, alert engine 212 may notify a realtor device 112. In another example, alert engine 212 could notify participant devices 102 when certain milestones occur. Such milestones include but are not limited to: The completion of paperwork between lender and prospective lendee, the expiration or imminent expiration of deadlines between lender and prospective mortgage, and a list of information that is still outstanding between lender and prospective lendee. In yet another example, alert engine 212 may alert participants if tasks 260 need to be completed (e.g., task status does not indicate completion), such as, a daily email to lendee to provide the necessary information to process a mortgage application. By alerting participant devices 102 of such information, the participants in a mortgage loan transaction can act upon it. For instance, if a realtor learns that a client has several pieces of outstanding information, the realtor can contact the client and direct the client to provide the lender with the requested information. In another example, when a realtor learns that the information in a file is complete, the realtor can begin the process of scheduling a closing date. Further, a realtor can set alerts that indicate when alert engine 212 will send notifications to realtor, such as for example, a daily alert to remind lendee to finish the paperwork, an alert one week from each due date to remind the realtor to follow up with appropriate parties, etc.

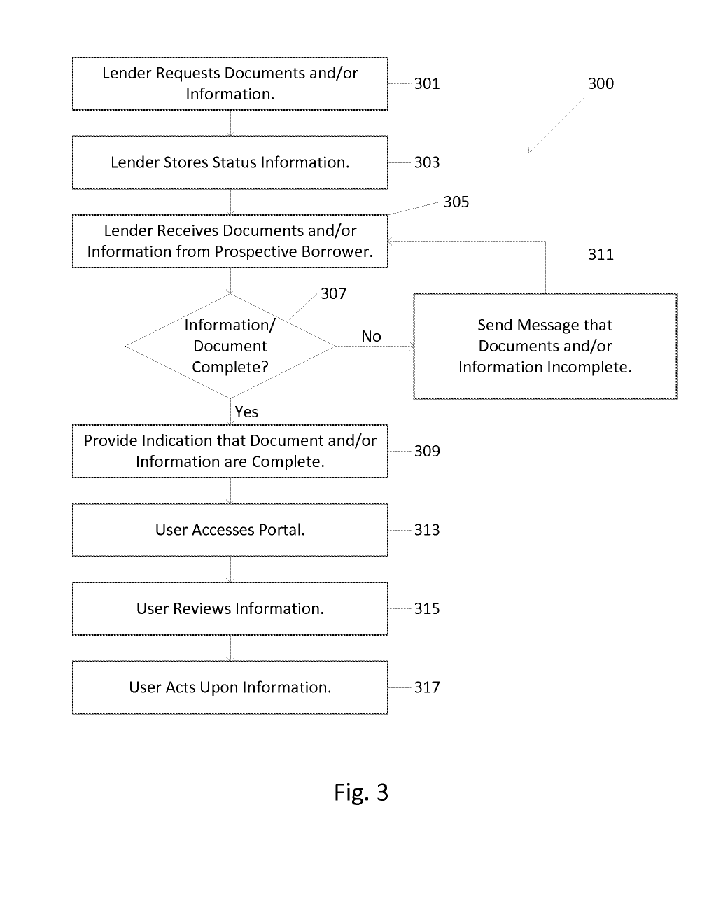

Referring to FIG. 3, exemplary operation of a process 300 of system 100 will now be described for illustrative purposes. In one embodiment, a lender requests, in step 301, from a prospective borrower certain information and/or documents in order to process the loan request. Such documents and information include, but are not limited to, personal information, financial information, and records pertaining thereto. The loan request in one embodiment is a mortgage request. Other transactions include, but are not limited to, commercial loans, automobile loans, home equity loans, and the like.

In step 303, the lender, in this case lender, stores information regarding the documents and information required to process the loan, in memory of lender device 108. In one embodiment, the information includes a listing of information that is necessary to close the loan transaction. In another embodiment, the information includes a listing of information that is received from the prospective borrower. In another embodiment, the information is a listing of the information that is received from the prospective borrower and an indication as to whether or not the information is valid.

In step 305, the lender receives documents and/or information from the prospective borrower.

In step 307, the lender determines whether or not the documents and/or information is complete. If the documents and/or information are complete, then the lender indicates that the documents and/or information are complete in the memory of lender device 108 in step 309. The portal device 106 may elect to notify lendee device 110 and realtor device 112 that such information is complete.

Otherwise, in step 311, the lender sends a message to lendee device 110 and realtor device 112 that incomplete documents and information have been received from lendee.

In step 313, a realtor logs into realtor portal 106 to view loan transactions related to the realtors account, including without limitation, a list of all pending and/or completed mortgage applications related to the realtor, a list of mortgage applications related to the realtor that meet certain criteria, such as active files, open/closed applications, due dates, the lender's identify, tasks that remain open, tasks that have been completed, etc. Realtor portal 106 provides the realtor with a variety of administrative options related to realtors account.

For instance, realtor may set alerts. Alerts are notifications that realtor requests when certain events occur. For instance, when one of realtor's clients submits information to a lender, alert engine 212 may send a notification to participants such as the realtor. In another example, notifications may be sent when one of realtor's clients fails to submit information to a lender. In another example, notifications may be sent when one of realtor's clients fails to submit information to a lender by a certain deadline. In a further example, the realtor could request alerts based on geotagging. For example, if realtor is using a mobile device, the realtor could request status reports as the realtor is in the proximity of a certain property. That is, as a realtor drives by a property that is of interest to realtor, portal device 106 could notify realtor of the status of the loan transaction occurring between the buyer of such property and the loan provider. If there is information that the buyer owes to a lender, portal device 106 could notify realtor.

In another instance, setting preference would allow realtor to specify the manner in which realtor wanted to receive information. For instance, realtor could request that portal notify realtor in certain ways. For instance, realtor might request text alerts, email, alerts, or phone alerts. Realtor may request a combination of such alerts depending on another variable, such as the time of day, the day of the week, or the date. In another embodiment, the realtor could specify the particular transactions that are interest to the realtor. For instance, the realtor may not want an entire listing of all transactions that realtor is in the process of closing. Instead, the realtor might want a listing of closing within a certain data range or geographical location.

Referring further to FIG. 3, in step 315, the realtor reviews information related to certain real estate transactions. Such transactions in one example are real estate loan transactions between a prospective lendee and a lender. The information can be provided to a realtor through in a number of ways, including plain text (e.g. SMS text, email) and/or multimedia (SMS video, voicemail, etc.). In one example, the information is a listing of information and/or documents that the prospective lendee needs to provide the lender.

Referring further to FIG. 3, in step 317, the realtor acts upon such information. In one example, the realtor acts upon such information by sending information to prospective lendee or lender over network 104. In one example, such information comprises a reminder message to prospective lendee to send information or documents to lender. In another example, such information comprises a request of status to lender. Such a request may include a request that lender review document and/or information sent by lendee and indicate whether such information is approved. It should be noted that the steps described in FIG. 3 are provided for illustrative purposes only. Such steps could be combined, divided, or reordered. Further, steps could be added or removed from the process flow.

In one embodiment, a lendee can identify potential homes they are considering purchasing via another computing system. These identified homes may be communicated to system 100, wherein if/when the lendee decides to purchase one of the homes, information about that home may be transferred to system 100.

In another embodiment, realtors cannot login to system 100 until the realtor has an active file (e.g., mortgage application), although it is considered herein that the realtor may be permitted to acquire login credentials in anticipation of a future active file.

In yet another embodiment, presentation engine 210 may provide reports to participants such as lender, wherein the reports may include, for exemplary purposes only, how many realtors have active files in system 100, how many buyers have active files, how many files have been closed (for a specified period of time), how many files are expected to close within a specified period of time, etc.

Accordingly, what is provided is a system and method that provides a realtor the ability to view mortgage loan status without having to contact the mortgagor or the prospective lendee. Once realtors have initial permission from mortgagor and prospective lendee, realtor can view mortgage loan status, can log into and have a better understanding of what documents are outstanding or if there are issues or delays with a mortgage loan. In one embodiment, the system and portal provides a user, such as a realtor, with the ability to view details including Once logged in to the portal, the realtor can view loan progression details that including outstanding/pending tasks for the realtor, borrower and lender; outstanding/pending documentation for the realtor, borrower and lender; completed tasks for the realtor, borrower and lender; completed documentation for the realtor, borrower and lender, and contact information for the mortgage processor.

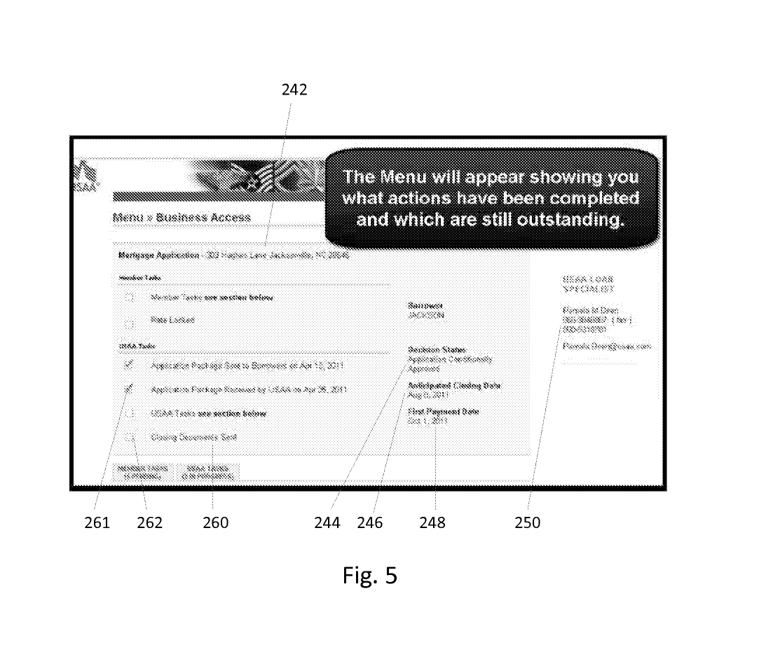

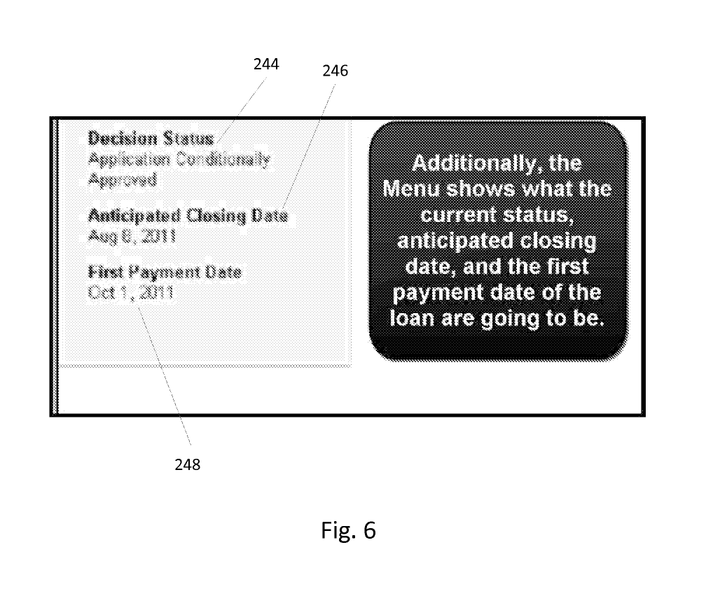

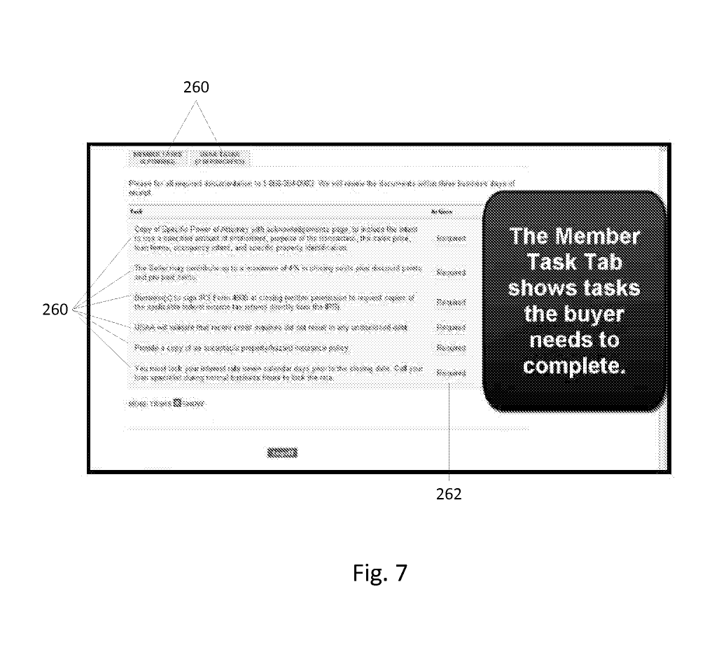

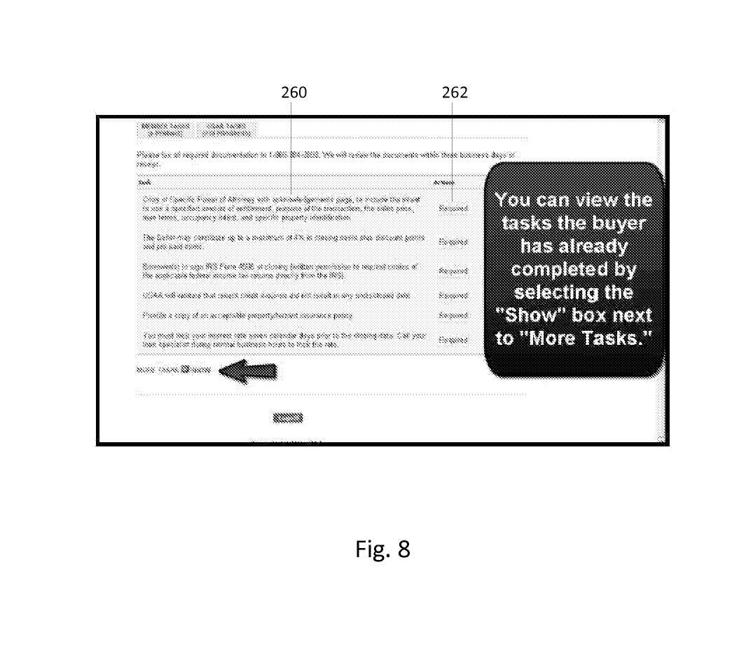

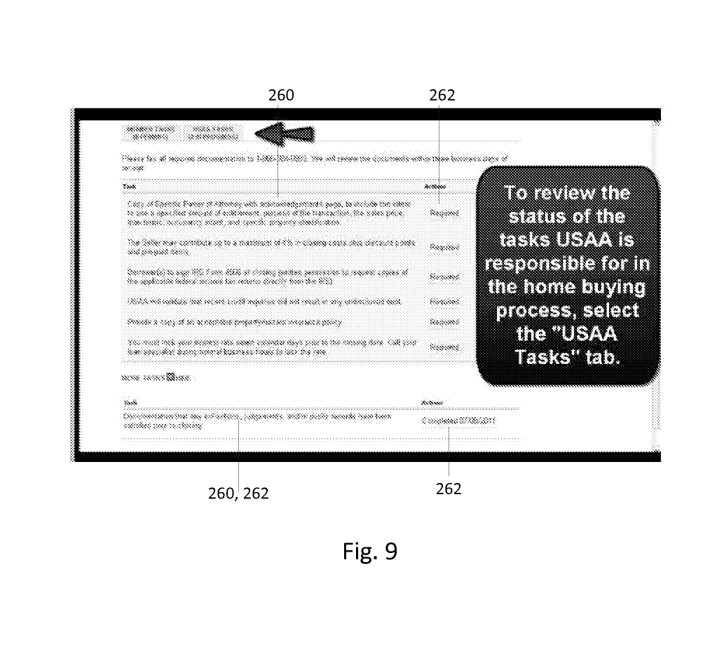

FIGS. 4-9 depict one exemplary embodiment of a realtor portal. In FIG. 4, the user of the portal is prompted to log-in. In one embodiment, the user logs in by entering login credentials 240 such as a borrowers name and a loan application number. In FIG. 5, a menu page is shown. The menu page shows a list of outstanding tasks 260, both from the lender and the lendee perspective. The menu page may also show information 242, task status 262, completed tasks 261, lender 250, decision status 244, closing date 246, and first payment date 248. In FIG. 6, it is shown that menu page also shows the current status of a loan transaction, including the anticipated closing date, and the first payment date. In FIG. 7, it is shown that there is task tab that shows a list of tasks 260 that the buyer (lendee) needs to complete. In FIG. 8, it is shown that there is the option of displaying tasks 260 that the lendee has already completed. In FIG. 9, it is shown that there is the option of displaying the task 260 that the lender (USAA) is responsible for completing. It must be noted that the proceeding Figs. are provided for illustrative purposes only, and should not be construed as limiting the scope of the disclosure to what is shown.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

Although the systems and methods of the subject invention have been described with respect to the embodiments disclosed above, those skilled in the art will readily appreciate that changes and modifications may be made thereto without departing from the spirit and scope of the subject invention.

What is claimed is:

1. A method for managing initiation of loans comprising:
receiving, at a portal device with a processor, a data interface, and memory with a database, information, the information relating to a proposed loan and including financial information, wherein the information is received from a lendee device operated by a lendee;
storing the information in the database; and
sending notification to a realtor that no more information is needed from the lendee.

2. The method of claim 1 further comprising:
sending an alert, via an alert engine, to a realtor device with a data interface and processor, the alert indicating that the stored information is complete.

3. The method of claim 2 further comprising:
generating tasks, the tasks relating to the proposed loan, wherein each task comprises a task status.

4. The method of claim 3 further comprising:
receiving a legal document relating to the proposed loan; and
storing the legal document in the database.

5. The method of claim 4 further comprising:
updating at least one task's status when the legal document is received.

6. The method of claim 5 further comprising:
setting an alert, via the alert engine, the alert comprising a notification sent to a realtor device when a task's status changes to completed.

7. The method of claim 5, wherein the legal document comprises an insurance policy for a property relating to the proposed loan.

8. The method of claim 7, wherein at least one task relates to setting an interest rate of the proposed loan.

9. The method of claim 8 further comprising:
generating an alert, via the alert engine, the alert relating to sending a notification to a realtor device when a task's status changes to completed.

10. The method of claim 8 further comprising:
generating an alert, via the alert engine, the alert relating to sending a notification to a realtor device when the realtor device is within a specified distance to a property, the property relating to the prospective loan.

11. The method of claim 10 further comprising:
sending a notification to a lendee device, operated by a prospective lendee of the prospective loan, the notification relating to a deadline.

12. The method of claim 11 further comprising:
sending a list of prospective loans to the realtor device, each prospective loan in the list relating to a realtor operating the realtor device.

13. A non-transitory computer readable storage medium and a computer program embedded therein, the computer program comprising instructions, which when executed by a computer system cause the computer system to:
receive, at a portal device with a processor, a data interface, and memory with a database, information, the information relating to a proposed mortgage and including financial information;
store the information in the database; and
send notification that the stored information is complete; and
generate tasks, the tasks relating to the proposed mortgage, wherein each task comprises a task status.

14. The non-transitory computer readable storage medium of claim 13, wherein the instructions further cause the computer system to:
receive a legal document relating to the proposed mortgage, wherein the legal document comprises an insurance policy for a property relating to the proposed mortgage; and
store the legal document in the database.

15. The non-transitory computer readable storage medium of claim 14, wherein the instructions further cause the computer system to:
generate an alert, via an alert engine, the alert relating to sending a notification to a realtor device if a task's status changes to completed.

16. The non-transitory computer readable storage medium of claim 15, wherein the instructions further cause the computer system to:
send an alert, via the alert engine, to a realtor device with a data interface and processor, the alert indicating that the stored information is complete.

17. A mortgage portal system comprising:
a portal device with a processor, memory with a database, and an alert engine, the alert engine sending notifications, wherein the database includes a mortgage application; and
a realtor computing device that is communicatively connected to the portal device.

18. The mortgage portal system of claim 17, wherein the database further includes information relating to the mortgage application, and a notification is sent when the information is incomplete.

19. The mortgage portal system of claim 17, wherein the database further includes information relating to the mortgage application, and a notification is sent when the information is complete.

20. The mortgage portal system of claim 19, wherein the database further includes tasks relating to the mortgage application, and wherein at least one task relates to receiving legal documents from a lendee of the mortgage application.
